(19) United States
(12) Patent Application Publication
(10) Pub. No.: US 2002/0133479 A1
(43) Pub. Date: Sep. 19, 2002

(54) Market research database for category management

(76) Inventor: James O. Dippold, Stamford, CT (US)

Correspondence Address: SCHIFF HARDIN & WAITE, 6600 SEARS TOWER, 233 S WACKER DR, CHICAGO, IL, 60606-6473, US

(21) Appl. No.: 09/810,238

(22) Filed: Mar. 16, 2001

(51) Int. Cl. G06F 7/00

(52) U.S. Cl. 707/1

(57) ABSTRACT

Data about first and second products are loaded into a data processor. The first product data relate to the movement of the first products through a first product supplier, and the second product data relate to the movement of the second products through a second product supplier. Definitions of product grouping of the first and second product suppliers are also loaded into the data processor. The first and second product data and links between the first and second products and the product groupings of the corresponding first and second product suppliers are stored. Access to the stored first and second product data is permitted by a third party, but the access is restricted by product supplier and/or by product grouping.

### TECHNICAL FIELD OF THE INVENTION

The present invention is directed to a market research database that facilitates the management of, and access to, product categories.

### BACKGROUND OF THE INVENTION

Data are collected and stored in a database for a variety of reasons. For example, it is known to collect market research data from a panel of product purchasers so that conclusions about the buying habits of specific population segments may be made. One such panel is operated by the A.C. Nielsen Company. The members of this panel store, in memory, data about the products which they purchase, and forward that data periodically to a central facility. For this purpose, these panelists are generally provided with UPC scanners which they use to scan and store the UPCs attached to the products that they purchase. An UPC, as is known in the art, is a uniform product code that is uniquely assigned to a product. The scanners are inserted into corresponding docking stations which serve to charge the scanners when the scanners are not in use, and to transmit the UPC information stored in the scanners to the central facility. This data is referred to herein as panelist data and allows a correlation between the products purchased by the panelists and the demographics of the panelists. At the central facility, the panelist data from all panelists are accumulated and correlated in order to generate appropriate reports about the buying habits of various population segments.

It is also known for a product supplier, such as a retailer, to collect data regarding its product sales so that the product supplier can determine the effectiveness of marketing programs, advertising, promotions, shelf or rack space allocations, product displays, and/or the like. For a retailer, this type of data is generally collected at the point-of-sale terminals where the sales to its customers are processed.

The product supplier might also want to correlate its product sales information with demographic information about its customers so that the product supplier can form conclusions regarding the types of people purchasing its products. For this purpose, it is known for a product supplier to issue customer identification cards which are used by its customers to identify themselves at the time that they make their purchases. Accordingly, the product supplier can correlate demographic information about its customers with its products sales.

Category management is also known. In the retail grocery store sector, exemplary categories may include Breakfast Cereals, Carbonated Beverages, Canned Fruits, etc. Category management supports, or should support, category strategies related to such functions as category business and merchandise planning, optimized item mixes and new item introductions within a category or across categories, optimized shelf management within a category or between categories, optimized pricing within a category or between categories, optimized merchandise promotion, category assessment, and category definitions.

However, category management is currently underdeveloped because, inter alia, it is difficult to load a market research database with data from multiple product suppliers. One of the reasons for this difficulty is that product suppliers seldom use the same product category definitions. Thus, when a market researcher receives product data from a product supplier, the market researcher must store this data according to the particular category definitions of the specific product supplier. Heretofore, the linking of product data to product categories has been accomplished manually. This manual effort is tedious and very time consuming and increases with each product supplier added to the database.

Furthermore, current category management has failed to fully recognize product suppliers' product categories as a business asset. For example, it is possible to use a database that contains data from multiple product suppliers not only to facilitate category strategies, item mixes, shelf management, pricing, merchandise promotion, category assessment, and category definitions as discussed above, but also to derive revenues by permitting a controlled and restricted access to the database by third parties such as manufacturers.

The present invention is directed to an arrangement in which data from multiple product suppliers may be more easily stored together in the same database and in which access is permitted to the data in the database by third parties on a controlled and restricted basis.

### SUMMARY OF THE INVENTION

According to one aspect of the present invention, a method is performed by a data processor to store data and to permit access to the stored data. The method comprises the following: a) loading data about products, wherein the product data relates to the movement of the products through a product supplier; b) loading definitions of product groupings of the product supplier; c) storing the product data loaded at a); d) storing product/product-grouping links according to the definitions loaded at b); and, e) allowing access to the product data by a third party, wherein the access is restricted by product grouping.

According to another aspect of the present invention, a method is performed by a data processor to store data and to permit access to the stored data. The method comprises the following: a) loading data about first products, wherein the first product data relate to the movement of the first products through a first product supplier; b) loading data about second products, wherein the second product data relate to the movement of the second products through a second product supplier; c) loading definitions of product groupings of the first product supplier; d) loading definitions of product groupings of the second product supplier; e) storing the product data loaded at a); f) storing first links between the first products and the product groupings of the first product supplier; g) storing the product data loaded at b); h) storing second links between the second products and the product groupings of the second product supplier; and, i) allowing access to the first and second product data by a third party, wherein the access is restricted by product supplier.

According to still another aspect of the present invention, a method is performed by a data processor to store data and to permit access to the stored data. The method comprises the following: collecting data relating to the movement of products through a plurality of product suppliers; storing the data in a common database by product supplier and by product grouping; and, allowing access to the data, wherein the access is restricted by product grouping and by product supplier.

According to yet another aspect of the present invention, a method is performed by a data processor to store data and to permit access to the stored data. The method comprises the following: collecting data relating to the movement of products through a plurality of product suppliers, wherein the data are collected by a first party, and wherein each product supplier is a second party; storing the data in a common database by product supplier and by product grouping, wherein the common database is maintained by the first party; and, allowing access to the data by a third party, wherein the access is permitted by the first party and is restricted by product grouping and by product supplier.

### BRIEF DESCRIPTION OF THE DRAWINGS

These and other features and advantages of the present invention will become more apparent from a detailed consideration of the invention when taken in conjunction with the drawings in which:

FIG. 1 is an exemplary processing and communication system which may be used to carry out the present invention;

FIG. 2 illustrates the flow of storing data in the exemplary processing and communication system of FIG. 1;

FIG. 3 illustrates the flow of refreshing the data stored in the exemplary processing and communication system of FIG. 1; and,

FIG. 4 illustrates the flow of accessing and transmitting authorized portions of the data stored in the exemplary processing and communication system of FIG. 1.

### DETAILED DESCRIPTION

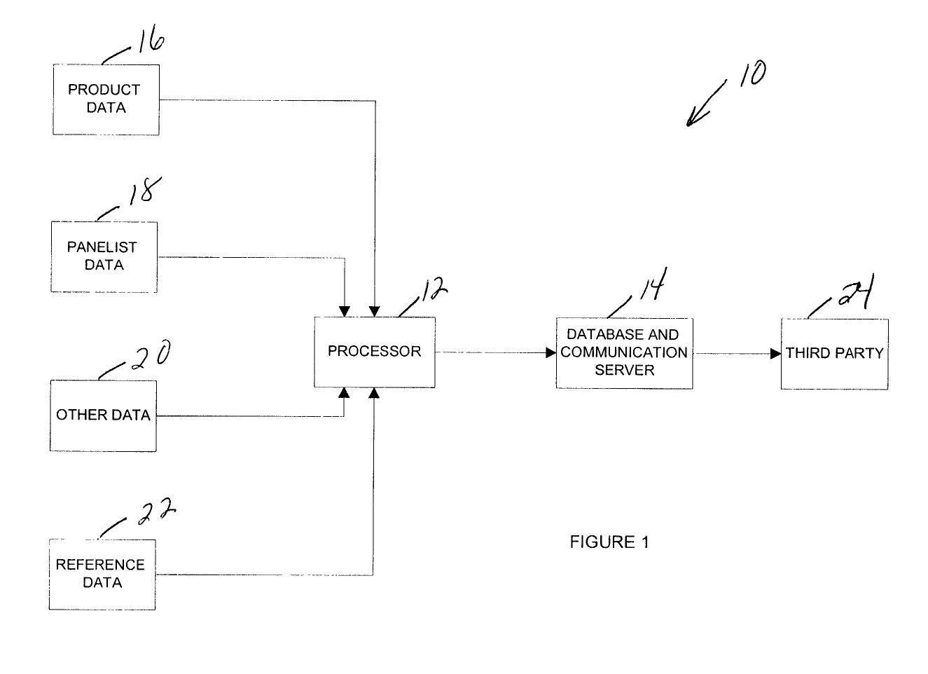

As shown in FIG. 1, an exemplary processing and communication system 10, which may be operated by a party such as a market researcher, includes a processor 12 and a database and communications server 14 coupled together so that the processor 12 can receive and process product related data and store that data in the database and communications server 14.

The processor 12 receives and processes data of different types. For example, the processor 12 receives product data 16 from product suppliers. The product data 16 may include, for example, UPC data, item movement data for each UPC and for each product supplier, the time period or periods covered by the item movement data, etc. The UPC data includes a list of UPCs corresponding to all of the products carried by the particular product supplier. This UPC data usually breaks the UPCs down by product category. The item movement data includes data about product sales and is most often generated at the point of sale terminals of the product suppliers. This point of sale data typically also includes information by UPC of the department within the corresponding product is carried. The product data 16 may also include demographic data to the extent that such data is available from each product supplier.

The processor 12 also receives panelist data 18 that is generated by the panelists of a product purchasing panel. The panelist data 18, for example, includes the UPCs of the products purchased by the panelists, the prices and quantities of the purchased products, the identity of the product supplier from whom the products were purchased, the identity of the panelists, the date on which the purchases were made, etc.

The processor 12 further receives other data 20 from each of the product suppliers. The other data 20, for example, may include the category definitions from each of the product suppliers. The other data 20 can also include data on marketing programs, advertising, promotions, shelf or rack space allocations, product displays, etc. Moreover, the processor 12 receives reference data 22 of a reference database which is described below.

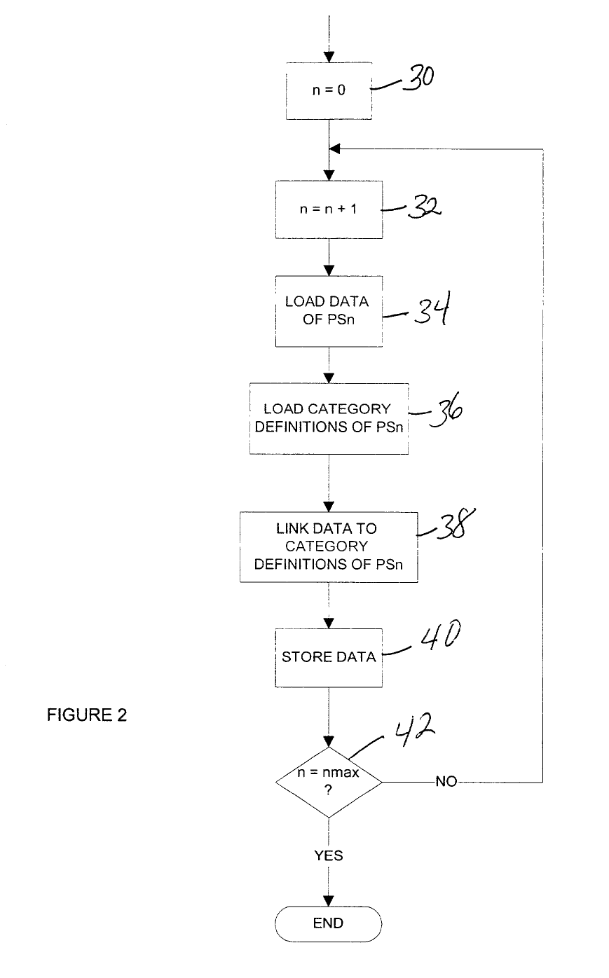

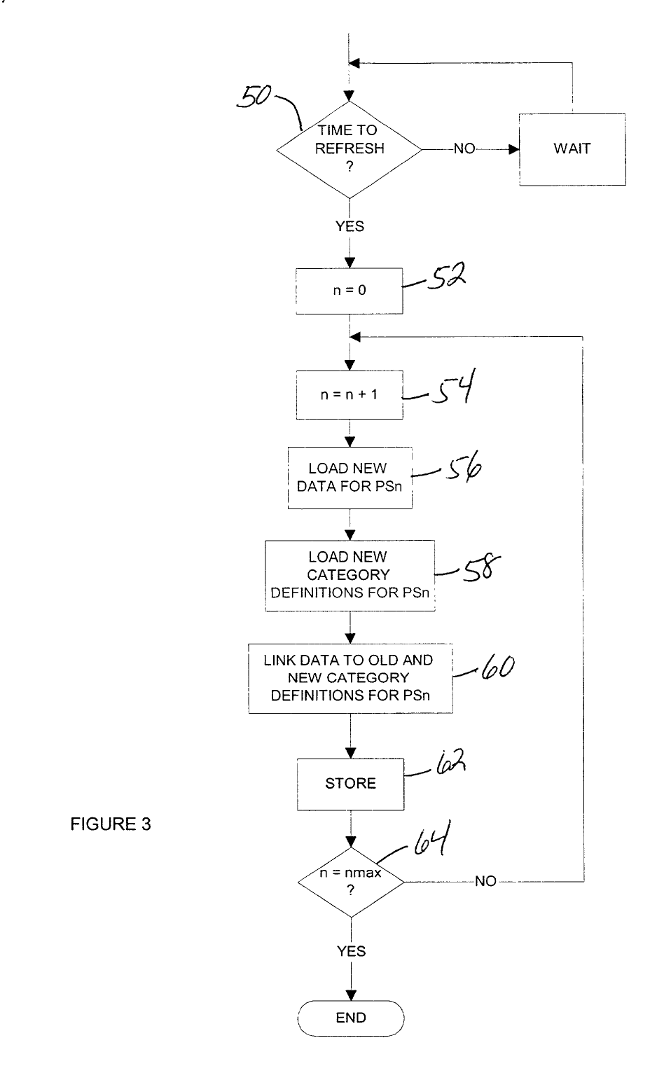

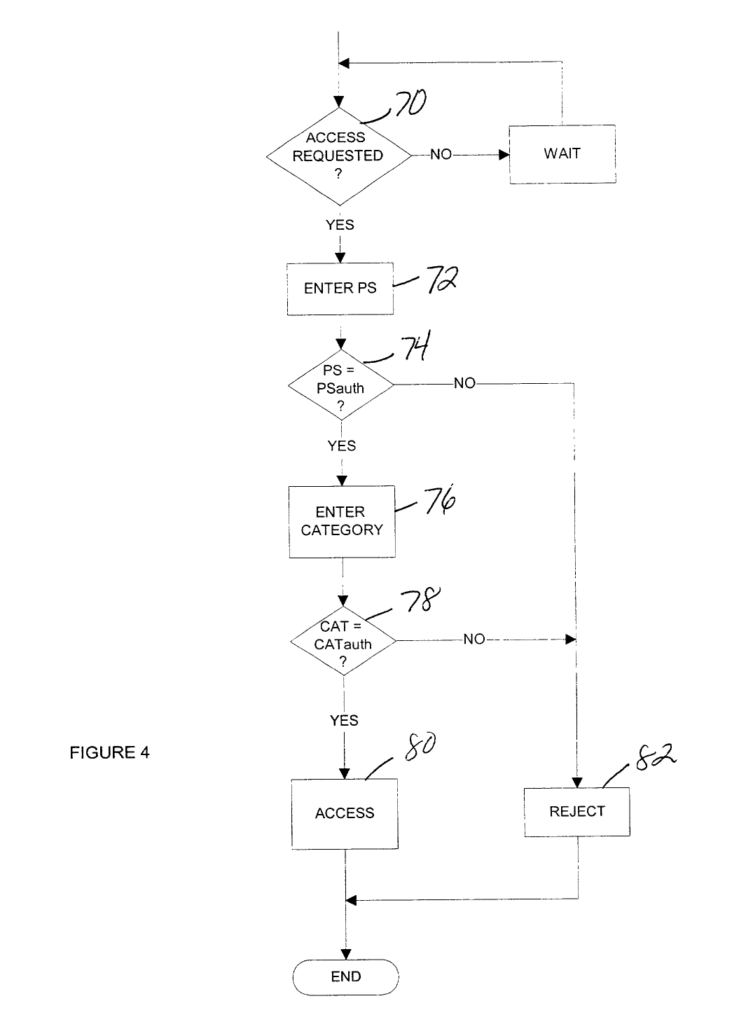

The processor 12 processes this data in accordance with the flow charts of FIGS. 2 and 3 and stores the processed data in the database and communications server 14. For convenience, the database portion of the database and communications server 14 may be a relational database. A third party 24 is then permitted restricted access to the stored data in accordance with the flow chart shown in FIG. 4. (The first two parties, for example, are the market researcher that maintains the exemplary processing and communication system 10 and the product suppliers.) The third party 24, for example, may be a manufacturer, a packager, a product supplier, etc.

As shown in FIG. 2, when the product data 16, the panelist data 18, and/or the other data 20 are available, a block 30 sets a variable n to zero and a block 32 increments the variable n by one. A block 34 then loads the portion of the product data 16 related to a corresponding one of the product suppliers designated as PSₙ in FIG. 2. Also, a block 36 loads the category definitions contained in the other data 20 for the product supplier PSₙ.

At this point, the product data loaded at the block 34 and the category definitions loaded at the block 36 are usually linked. That is, the data loaded at the block 34 are data for each product carried by the product supplier PSₙ and includes (i) the UPC for the corresponding product, (ii) movement data for the corresponding product, (iii) any other sales data relating to the corresponding product which are relevant to category management and/or to the third party 24, and (iv) the category to which the product supplier PSₙ has assigned the product according to the category definition of the product supplier PSₙ. Products that the product supplier PSₙ do not carry, however, are not linked to the categories of the product supplier PSₙ. Products that are not linked to categories are referred to herein as uncategorized products. On the other hand, products that are linked to categories are referred to herein as categorized products.

Accordingly, at a block 38, UPCs of uncategorized products (products not carried by the product supplier PSₙ) are linked to categories according to the category definitions supplied by the product supplier PSₙ. This linking can be done manually. However, a manual linking of the UPCs of uncategorized products to categories according to the category definitions of a product supplier is tedious and time consuming. Accordingly, an automatic approach to linking can be implemented. For example, a procedure as described in co-pending application Ser. No. 09/512,498, filed on Feb. 24, 2000 can be used to automatically link the UPCs of uncategorized products to the categories as defined by the product supplier PSₙ.

In this automatic procedure, first and second groups of data are, in effect, compared to one another. The first group of data includes product characteristics by UPC as stored in a reference database. Product characteristics characterize products or other items or services and are used as a standard or baseline against which the category definitions of the product supplier PSₙ may be analyzed. A reference database which may be used for this purpose is Product Reference that is maintained by the assignee of the present application. However, any other similar database can be used.

The characteristic data may be of two kinds, characteristic types and characteristic values. Characteristic types include such attributes as flavor, size, color, and the like that qualitatively characterize products. Characteristic values include such attributes as chocolate, vanilla, ounces, pounds, liter, red, orange, and the like, and are used to qualify and/or quantify the characteristic type.

The second group of data includes the UPCs and the corresponding product categories as defined by the category definitions contained in the other data 20. The products which correspond to those UPCs that are common to both the first and second groups of data are the categorized products discussed above.

As implemented according to the aforementioned application, the block 38 determines the intersection between the first and second groups of data. That is, the UPCs that are common to the first and second groups of data, together with the characteristics from the first group of data that relate to the common UPCs, are defined as intersection data.

This intersection data could be processed as is, or it can be compressed for more efficient processing. For example, string compression may be implemented to compress the intersection data. That is, the characteristic that occurs most frequently in the intersection data is assigned a first label that is short compared to the characteristic itself. Then, the characteristic that occurs the next most frequently in the intersection data is assigned a second label that is short compared to the characteristic itself, and so on.

Moreover, although the block 38 may mine the intersection data category by category for the categories included in the intersection data, it may be more efficient to organize the intersection data into data subsets 0-k, where k has a value depending upon the amount of intersection data and the criterion used to organize the intersection data. The criterion may be a category-like characteristic referred to as characteristic j, where j represents different values of the criterion. For example, in terms of Product Reference, each value of characteristic j may indicate a corresponding competitive category or a corresponding commodity group. All or nearly all UPCs in Product Reference are assigned to a competitive category and/or to a commodity group.

Next, a data mining software such as “Wizwhy”®, which is a commercially available data mining software program supplied by WizSoft, is run on the intersection data as a whole, or subset by subset if the intersection data are reformatted as discussed above. Wizwhy generates a rule file based upon the intersection data in the subset currently being processed, where the rule file contains scoring rules. These scoring rules are if-then scoring rules and are generated for each characteristic type and value. Wizwhy creates two kinds of if-then scoring rules, i.e., “is if-then” scoring rules and “is not if-then” scoring rules. An “is if-then” scoring rule, for example, has the following format: if flavor is chocolate, then category is CAT A. Similarly, an “is not if-then” scoring rule, for example, has the following format: if flavor is chocolate, then category is not CAT B. Predictor variables and criterion variables must be specified for the Wizwhy program. The predictor variables for the Wizwhy program are the characteristic types from the intersection data. The criterion variables produced by the Wizwhy program are the categories of the product supplier PSₙ as contained in the intersection data.

Wizwhy and these scoring rules are used by the block 38 to score the categorized product data provided by the product supplier PSₙ. As indicated above, the categorized product data are those product data of the product supplier PSₙ which intersects with the first group of data. This scoring assigns each of the UPCs from the product data of the product supplier PSₙ to a category and also determines a conclusive probability corresponding to that assignment. When a UPC is assigned to more than one category, the final category for a UPC is chosen on the basis of the assignment having the highest conclusive probability. Thus, this scoring indicates whether there is agreement between the product categorizations provided by the product supplier PSₙ and the product categorizations resulting from the scoring as based upon the reference database. Any disagreements may be corrected automatically, or they may be corrected only after the assent of the product supplier PSₙ.

The uncategorized product data, i.e., the product data in the first group of data that do not intersect with the data supplied by the product supplier PSₙ, are similarly processed and scored so that a UPC corresponding to a product that the product supplier PSₙ does not carry is also assigned to a category according to the category definitions provided by the product supplier PSₙ.

These links between UPCs and categories for both categorized product data and uncategorized product data are stored at a block 40 in the database portion of the database and communications server 14 along with the product data 16, the panelist data 18, and the other data 20. For ease of retrieval and report generation, the product data 16, the panelist data 18, and the other data 20, where applicable, may be stored in relation to the UPCs to which the data pertains. A block 42 then tests the variable n to determine whether the product data 16 and the other data 20 from each of the other product suppliers has been processed by the blocks 34-40. If not, program flow returns to the block 32 where n is incremented by one and the data from the next product supplier are processed according to the blocks 34-40. If the product data 16 and the other data 20 from each of the other product suppliers has been processed by the blocks 34-40 as determined by the block 42, then the processing of data by the processor 12 is ended.

The data stored in the database portion of the database and communications server 14 must be periodically refreshed and updated if this database is to retain its value. For example, the database may be refreshed according to the flow of FIG. 3. As shown in FIG. 3, if a block 50 determines that it is time to refresh, such as when new data is available, when category definitions have been added or changed, and/or after a predetermined amount of time has passed since the last refresh, a block 52 sets a variable n to zero, and a block 54 increments the variable n by one. A block 56 then loads any new product data related to a corresponding one of the product suppliers designated as PSₙ in FIG. 3. Also, a block 58 loads any new or additional category definitions for the product supplier PSₙ. (New other data and panelist data can also be loaded at the blocks 56 and 58.)

At this point, the product data loaded at the block 56 may or may not be linked to the existing category definitions or to the new category definitions loaded at the block 58. That is, much of the data loaded at the block 56 is new data related to UPCs already processed by the flow of FIG. 2. This data does not need to be re-linked unless category definitions have been changed. However, the new data may also contain new UPCs. To the extent that such new UPCs have already been linked to categories by the product supplier PSₙ, such linkages need to be verified. To the extent that such new UPCs have not already been linked to categories by the product supplier PSₙ, such linkages need to be made.

Accordingly, the linkages between the new UPCs and the category definitions of the particular product supplier PSₙ are verified or made, as appropriate, at a block 60. The block 60 may operate in a similar manner to the block 38 described above in relation to FIG. 2. Also, if category definitions have been changed or added, all old and new UPCs must be linked to the new category definitions of the particular product supplier PSₙ at the block 60, and UPCs of unknown products must also be linked to the new category definitions of the particular product supplier PSₙ at the block 60.

The links between UPCs and categories are stored at a block 62 in the database portion of the database and communications server 14 along with the product data 16, the panelist data 18, and the other data 20 which are new. If there were no new UPCs and no category changes, no links are determined by the block 60 and the block 62 merely stores the new data.

A block 64 then tests the variable n to determine whether the new data from each of the other product suppliers has been processed by the blocks 56-62. If not, program flow returns to the block 54 where n is incremented by one and the data from the next product supplier are processed according to the blocks 56-62. If the new data from each of the other product suppliers have been processed by the blocks 56-62 as determined by the block 64, then database refreshing is ended.

The third party 24 is permitted access to the database portion of the database and communications server 14 according to the flow of FIG. 4. When a request for access to the database is received from the third party 24 as determined at a block 70, the third party 24 is prompted to enter certain information. For example, the third party 24 is prompted at a block 72 to enter the identity of the product supplier who supplied the data that the third party 24 is requesting. A block 74 tests the identity entered at the block 72 in order to determine whether the third party 24 is authorized to access the database for the data corresponding to this product supplier. For example, the block 72 may consult a list linking the third party 24 with the identities of those product suppliers according to a prior arrangement with the market researcher and/or with the relevant product supplier.

If the block 74 determines that the third party 24 is authorized to access the database for the data corresponding to the product supplier identified at the block 72, the third party 24 is also prompted at a block 76 to enter a category designation corresponding to a category for which the third party 24 is requesting data. A block 78 tests the category designation entered at the block 76 in order to determine whether the third party 24 is authorized to access the database for the data corresponding to this category. For example, the block 78 may consult a list linking the third party 24 with the category designations according to a prior arrangement with the market researcher and/or with the relevant product supplier.

If the block 78 determines that the third party 24 is authorized to access the database for data corresponding to the category designated at the block 76, the third party 24 is allowed access at a block 80 to the data of the identified product supplier and in the designated category in a format specified by the third party 24.

If the block 74 determines that the third party 24 is not authorized to access the database for the data corresponding to the product supplier identified at the block 72, or if the block 78 determines that the third party 24 is not authorized to access the database for the data corresponding to the category designated at the block 76, the request of the third party 24 is rejected at a block 82. The block 82 may be arranged to indicate why the request of the third party 24 has been rejected (e.g., access to the data of the entered product supplier or in the entered category is not authorized). The block 82 may or may not be arranged to permit the third party 24 to make another request. If the block 82 is arranged to permit the third party 24 to make another request, the block 82 may be arranged to terminate requests after a predetermined number of unsuccessful requests by the third party 24.

Certain modifications of the present invention have been discussed above. Other modifications will occur to those practicing in the art of the present invention. For example, the blocks 72 and 76 are shown as separate blocks. However, the functions of these blocks may be performed at the same time at a single block, in which case the functions of the blocks 74 and 78 may also be combined at a single block.

Also, the flow of FIG. 4 may be varied such that only one or the other of the tests at blocks 74 and 78 is performed.

In addition, as described above, the exemplary processing and communication system 10 is operated by a party such as a market researcher. Therefore, it should be understood that parties other than market researchers can operate the exemplary processing and communication system 10.

Moreover, the invention has been described above in terms of products categories. However, the present invention is useful with other product groupings such as sub-categories, departments, etc.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A method performed by a data processor of storing data and permitting access to the stored data comprising:
a) loading data about products, wherein the product data relates to the movement of the products through a product supplier;
b) loading definitions of product groupings of the product supplier;
c) storing the product data loaded at a);
d) storing product/product-grouping links according to the definitions loaded at b); and,
e) allowing access to the product data by a third party, wherein the access is restricted by product grouping.

2. The method of claim 1 wherein the data loaded at a) comprises UPCs of the products, and wherein d) comprises storing links between the UPCs and the product groupings.

3. The method of claim 1 further comprising:
determining links between (i) products that do not move through the product supplier and (ii) the product groupings of the product supplier; and,
storing the links between (i) the products that do not move through the product supplier and (ii) the product groupings of the product supplier.

4. The method of claim 3 wherein the determination of links between (i) products that do not move through the product supplier and (ii) the product groupings of the product supplier comprises comparing the product data loaded at a) to reference data.

5. The method of claim 1 wherein the data loaded at a) comprises UPCs of the products that move through the product supplier, and wherein d) comprises:
storing the links between (i) the UPCs of the products that move through the product supplier and (ii) the product groupings; and,
storing links between (i) UPCs of products that do not move through the product supplier and (ii) the product groupings.

6. The method of claim 1 wherein the product data loaded at a) includes panelist data.

7. The method of claim 6 wherein the product data loaded at a) includes point of sale data.

8. The method of claim 1 further comprising refreshing the stored data and/or the product/product-grouping links.

9. The method of claim 1 wherein the product data loaded at a) includes the product/product-grouping links.

10. The method of claim 9 further comprising verifying the product/product-grouping links.

11. A method performed by a data processor of storing data and permitting access to the stored data comprising:
a) loading data about first products, wherein the first product data relate to the movement of the first products through a first product supplier;
b) loading data about second products, wherein the second product data relate to the movement of the second products through a second product supplier;
c) loading definitions of product groupings of the first product supplier;
d) loading definitions of product groupings of the second product supplier;
e) storing the product data loaded at a);
f) storing first links between the first products and the product groupings of the first product supplier;
g) storing the product data loaded at b);
h) storing second links between the second products and the product groupings of the second product supplier; and,
i) allowing access to the first and second product data by a third party, wherein the access is restricted by product supplier.

12. The method of claim 11 wherein the data loaded at a) comprises UPCs of the first products, wherein the data loaded at b) comprises UPCs of the second products, wherein the first links stored at f) comprises links between the UPCs of the first products and the product groupings of the first product supplier, and wherein the second links stored at h) comprises links between the UPCs of the second products and the product groupings of the second product supplier.

13. The method of claim 12 further comprising:
storing third links between (i) UPCs of products that do not move through the first product supplier and (ii) the product groupings of the first product supplier; and,
storing fourth links between (i) UPCs of products that do not move through the second product supplier and (ii) the product groupings of the second product supplier.

14. The method of claim 11 further comprising:
determining third links between (i) products that do not move through the first product supplier and (ii) the product groupings of the first product supplier;
determining fourth links between (i) products that do not move through the second product supplier and (ii) the product groupings of the second product supplier; and,
storing the third and fourth links.

15. The method of claim 14 wherein the determination of the third links comprises comparing the data loaded at a) to reference data so as to determine the products that do not move through the first product supplier, and wherein the determination of the fourth links comprises comparing the data loaded at b) to the reference data so as to determine the products that do not move through the second product supplier.

16. The method of claim 11 further comprising loading panelist data.

17. The method of claim 16 wherein the data loaded at a) includes point of sale data, and wherein the data loaded at b) includes point of sale data.

18. The method of claim 11 further comprising refreshing the data and links stored at e), f), g), and h).

19. The method of claim 11 wherein the first product data loaded at a) includes the first links, and wherein the second product data loaded at b) includes the second links.

20. The method of claim 19 further comprising verifying the first and second links.

21. The method of claim 11 wherein the access at i) is restricted by product supplier and by product grouping.

22. The method of claim 21 wherein the data loaded at a) comprises UPCs of the first products, wherein the data loaded at b) comprises UPCs of the second products, wherein the first links stored at f) comprises links between the UPCs of the first products and the product groupings of the first product supplier, and wherein the second links stored at h) comprises links between the UPCs of the second products and the product groupings of the second product supplier.

23. The method of claim 22 further comprising:
storing third links between (i) UPCs of products that do not move through the first product supplier and (ii) the product groupings of the first product supplier; and,
storing fourth links between (i) UPCs of products that do not move through the second product supplier and (ii) the product groupings of the second product supplier.

24. The method of claim 21 further comprising:
determining third links between (i) products that do not move through the first product supplier and (ii) the product groupings of the first product supplier;
determining fourth links between (i) products that do not move through the second product supplier and (ii) the product groupings of the second product supplier; and,
storing the third and fourth links.

25. The method of claim 24 wherein the determination of the third links comprises comparing the data loaded at a) to reference data so as to determine the products that do not move through the first product supplier, and wherein the determination of the fourth links comprises comparing the data loaded at b) to the reference data so as to determine the products that do not move through the second product supplier.

26. The method of claim 21 further comprising loading panelist data.

27. The method of claim 26 wherein the data loaded at a) includes point of sale data, and wherein the data loaded at b) includes point of sale data.

28. The method of claim 21 further comprising refreshing the data and links stored at e), f), g), and h).

29. The method of claim 21 wherein the first product data loaded at a) includes the first links, and wherein the second product data loaded at b) includes the second links.

30. The method of claim 29 further comprising verifying the first and second links.

31. A method performed by a data processor of storing data and permitting access to the stored data comprising:
collecting data relating to the movement of products through a plurality of product suppliers;
storing the data in a common database by product supplier and by product grouping; and,
allowing access to the data, wherein the access is restricted by product grouping and by product supplier.

32. The method of claim 31 wherein the stored data includes data about products that do not move through the product suppliers, and wherein the data about products that do not move through the product suppliers are stored by product grouping and by product supplier.

33. The method of claim 31 wherein the data are stored according to identifiers common to all of the product suppliers.

34. The method of claim 33 wherein the identifiers are UPCs.

35. The method of claim 33 wherein the stored data includes data about products that do not move through the product suppliers, and wherein the data about products that do not move through the product suppliers are stored by product grouping and by product supplier.

36. The method of claim 31 further comprising refreshing the stored data.

37. A method performed by a data processor of storing data and permitting access to the stored data comprising:
collecting data relating to the movement of products through a plurality of product suppliers, wherein the data are collected by a first party, and wherein each product supplier is a second party;
storing the data in a common database by product supplier and by product grouping, wherein the common database is maintained by the first party; and,
allowing access to the data by a third party, wherein the access is permitted by the first party and is restricted by product grouping and by product supplier.

38. The method of claim 37 wherein the first party is unrelated to the second parties.

39. The method of claim 37 wherein the first party is unrelated to the third party.

40. The method of claim 37 wherein the third party is unrelated to the second parties.

41. The method of claim 37 wherein the first, second, and third parties are unrelated to one other.

42. The method of claim 37 wherein the first party is a market researcher, and wherein the third party is a manufacturer.
